(19) United States
(12) Patent Application Publication
(10) Pub. No.: US 2026/0289842 A1
(43) Pub. Date: Sep. 24, 2026

(54) DISPLAY METHOD AND APPARATUS, COMPUTING DEVICE, MEDIUM AND PROGRAM PRODUCT

(71) Applicant: Beijing Zitiao Network Technology Co., Ltd., Beijing (CN)

(72) Inventors: Chenyun Zeng, Beijing (CN); Shengfan He, Beijing (CN)

(21) Appl. No.: 19/572,365

(22) Filed: Mar. 19, 2026

(30) Foreign Application Priority Data
Mar. 19, 2025 (WO) PCT/CN2025/083582

(51) Int. Cl. G06T 11/26; G06F 16/26; G06T 3/40

(52) U.S. Cl. CPC G06T 11/26; G06F 16/26; G06T 3/40; G06T 2200/24

(57) ABSTRACT

The present disclosure provides a display method and apparatus, a computing device, a medium and a computer program product. The method includes: displaying a view comprising a node-edge graph, the node-edge graph comprising an aggregation node composed of a plurality of nodes, and a first node directly connected to the aggregation node; and in response to receiving a first interaction operation for the aggregation node, simultaneously displaying an enlarged aggregation node and the first node connected with the enlarged node in the view, wherein a structural diagram of the plurality of nodes included in the aggregation node is displayed in the enlarged aggregation node.

### CROSS-REFERENCE TO RELATED APPLICATIONS

This application claims priority to PCT Application No. PCT/CN2025/083582 filed on Mar. 19, 2025, the disclosure of which is incorporated herein by reference in its entirety.

### FIELD

The present disclosure relates to the technical field of computers, and more specifically, to a display method and apparatus, a computing device, a computer storage medium and a computer program product.

### BACKGROUND

A node-edge graph (also referred to as a graph structure) consists of nodes and edges. The nodes are used to represent various entities, and the edges are used to describe associations among the nodes. The node-edge graph, as a common data visualization tool, is widely applied to present and analyze complex data relationships, which can directly display the associations between data by means of the topological structure of nodes and edges.

### SUMMARY

Embodiments of the present disclosure provide a display method and apparatus, a computing device, a computer storage medium and a computer program product.

In a first aspect of the present disclosure, there is provided a display method, comprising: displaying a view comprising a node-edge graph, the node-edge graph comprising an aggregation node composed of a plurality of nodes, and a node directly connected to the aggregation node; and in response to receiving a first interaction operation for the aggregation node, simultaneously displaying an enlarged aggregation node and the node connected with the enlarged node in the view, wherein structural diagram of the plurality of nodes included in the aggregation node is displayed in the enlarged aggregation node.

In a second aspect of the present disclosure, there is provided a display apparatus, comprising: a display unit configured to display a view comprising a node-edge graph, the node-edge graph comprising an aggregation node composed of a plurality of nodes, and a node directly connected to the aggregation node; and an enlarging unit configured to simultaneously display, in response to receiving a first interaction operation for the aggregation node, an enlarged aggregation node and the node connected with the enlarged node in the view, wherein structural diagram of the plurality of nodes included in the aggregation node is displayed in the enlarged aggregation node.

In a third aspect of the present disclosure, there is provided a computing device, comprising: at least one processing unit; and at least one memory coupled to the at least one processing unit and storing instructions executable by the at least one processing unit, wherein the instructions, when executed by the at least one processing unit, cause the computing device to perform the method in the first aspect of the present disclosure.

In a fourth aspect of the present disclosure, there is provided a non-transitory computer storage medium, comprising machine-executable instructions that, when executed by a device, cause the device to perform the method in the first aspect of the present disclosure.

In a fifth aspect of the present disclosure, there is provided a computer program product comprising machine-executable instructions that, when executed by a device, cause the device to perform the method in the first aspect of the present disclosure.

It would be appreciated that the Summary is not intended to identify key features or essential features of the present disclosure, nor is it intended to be used to limit the scope of the present disclosure. Other features of the present disclosure will be made apparent through the following description.

### BRIEF DESCRIPTION OF THE DRAWINGS

With reference to the following detailed description of the accompanying drawings, the above and other objectives, features, and advantages of the embodiments of the present disclosure will be made clearer. In the drawings, multiple embodiments of the present disclosure are depicted in an exemplary, but non-limiting, manner, where:

FIG. 1 illustrates a schematic flowchart of a display method according to embodiments of the present disclosure;

FIG. 2 illustrates a schematic diagram of a view, in which an aggregation node is in a collapsed state, according to embodiments of the present disclosure;

FIG. 3 illustrates a schematic diagram of a view, in which an aggregation node in an expanded state, according to embodiments of the present disclosure;

FIG. 4 illustrates a schematic diagram of a view, in which an aggregation node is to be collapsed, according to embodiments of the present disclosure;

FIG. 5 illustrates a schematic diagram of a view of a thumbnail for displaying an aggregation node according to embodiments of the present disclosure;

FIG. 6 illustrates a schematic diagram of a view, in which node-edge structures within bubbles are highlighted, according to embodiments of the present disclosure;

FIG. 7 illustrates a schematic diagram of a view, in which a part of node-edge structures within bubbles are highlighted, according to embodiments of the present disclosure;

FIG. 8 illustrates a block diagram of a display apparatus according to embodiments of the present disclosure; and

FIG. 9 illustrates a block diagram of an electronic device according to embodiments of the present disclosure.

Throughout the drawings, the same or similar reference numerals represent the same or similar elements.

### DETAILED DESCRIPTION OF EMBODIMENTS

Reference below will be made to describe the embodiments of the present disclosure in detail. Although some embodiments of the present disclosure are depicted in the drawings, it would be appreciated that the present disclosure could be implemented in various forms and should not be construed as being restricted to the embodiments described herein. Rather, those embodiments are provided to enable a more thorough and complete understanding of the present disclosure. It is to be understood that the drawings and embodiments of the present disclosure are provided only exemplarily, but not used to limit the protection scope of the present disclosure.

As described herein, the term “includes” or similar expressions are to be read as open-ended terms that mean “includes, but is not limited to.” The term “based on” is to be read as “based at least in part on.” The term “an embodiment” or “the embodiment” is to be read as “at least one embodiment.” The terms “first,” “second,” and the like may refer to different objects or the same object unless explicitly indicated otherwise. Other definitions, explicit and implicit, may be included below.

Hereinafter, reference will be made to the drawings to describe the basic principle and implementations of the present disclosure. It would be appreciated that the example embodiments are provided only to enable those skilled in the art to better understand and further carry out the embodiments of the present disclosure, rather than suggest any limitation to the scope of the present disclosure.

In some node-edge graphs, it is allowed to use an aggregation node to indicate a set of associated nodes, to display the overall relationship between the set of nodes and other nodes, and a multi-level node structure is formed accordingly. However, this poses a challenge to the display of the node-edge graph.

In related arts, a hierarchical display scheme is typically applied to a node-edge graph to process the multi-level node structure. For example, if a first-level aggregation node contains a plurality of second-level nodes, it is required, according to the legacy solution, to display detailed information of the second-level nodes by directing to a new page or an independent view (e.g. switching animations through a prop-up window or page). If a user intends to view a structural diagram of the second-level nodes included in the aggregation node in the node-edge graph, it is generally required to display detailed information of the second-level nodes by directing to a new page or an independent view (e.g. switching animations through a prop-up window or page), which brings about a cumbersome viewing process and leads to a failure at directly viewing the structural diagram of the second-level nodes included in the aggregation node. Moreover, if the structural diagram of the second-level nodes is viewed in the new page or independent view, the relationships between the second-level nodes and other nodes than the aggregation node will be neglected.

To this end, the present disclosure provides a display method. In the method, a view including a node-edge graph can be displayed on the screen, where the node-edge graph includes an aggregation node composed of a plurality of nodes, and a node directly connected to the aggregation node. When a first interaction operation for the aggregation node is received, an enlarged aggregation node and the node connected with the enlarged node are simultaneously displayed in the view, where a structural diagram of the plurality of nodes included in the aggregation node is displayed in the enlarged aggregation node.

With the method, second-level nodes included in the aggregation node can be viewed by clicking on an aggregation node, while it is unnecessary to jump to a new page or view to view a structural diagram included in the aggregation node. In this way, the aggregation node and the structural diagram of the second-level nodes can be displayed in the same view, which can reduce the operation steps required to view the structural diagram of the plurality of second-level nodes included in the aggregation node, and enable the user to directly view the structural diagram and the relationships between the aggregation node and other nodes at the same time.

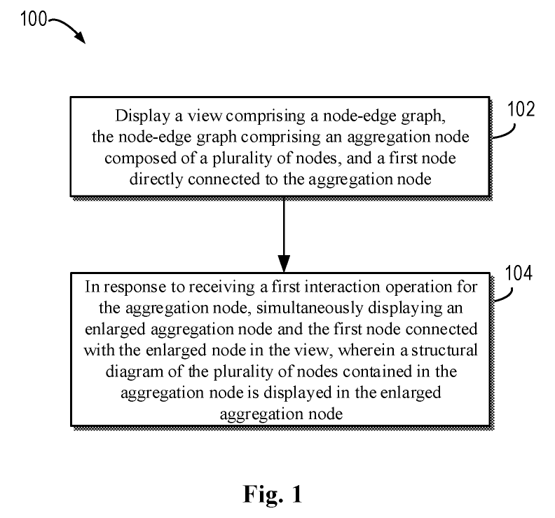

FIG. 1 illustrates a schematic flowchart of a display method 100 according to embodiments of the present disclosure. The method can be implemented by any electronic device with computing and display capabilities, including, but not limited to, a mobile phone, a tablet, a wearable device, an on-vehicle device, an augmented reality/virtual reality device, a laptop computer, an ultra-mobile personal computer, a netbook computer, a personal digital assistant, an IoT device, an industrial terminal, and other electronic device with an interface display function. The specific type of the electronic device is not limited herein.

In the method 100 as shown in FIG. 1, in block 102, a view including a node-edge graph is displayed, where the node-edge graph includes an aggregation node composed of a plurality of nodes, and a node directly connected to the aggregation node.

In some implementations, the node-edge graph in the view may mainly consist of two types elements, where one type is the aggregation node, and the other type is the node connected to the aggregation node. The aggregation node is formed by combining a plurality of nodes (i.e., second-level nodes) with respect to logical or functional associations. Nodes (i.e., first-level nodes) directly connected to the aggregation node form topological connections with the aggregation node through edge elements, thus forming a complete node-edge graph. The nodes within the aggregation node have relationships represented by edges, and a structural diagram is formed accordingly.

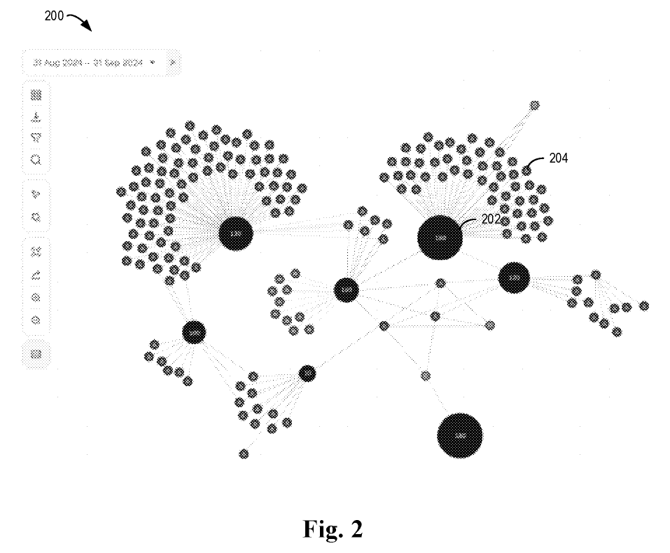

FIG. 2 illustrates a schematic diagram of a view 200, in which an aggregation node is in a collapsed state, according to embodiments of the present disclosure. As shown therein, the view 200 displayed on the screen of the device may include an aggregation node 202, and a node 204 connected to the aggregation node 202.

The view 200 may include the aggregation node 202, and more aggregation nodes not shown. A number can be displayed on one or more aggregation nodes in the node-edge graph, where the number represents the quantity of the plurality of second-level nodes included in the aggregation node. By way of example, the number on the aggregation node 202 is 180, which indicates that the aggregation node 202 contains 180 second-level nodes.

In some embodiments, the size of the aggregation node is determined based on the quantity of the plurality of nodes included in the aggregation node. For example, the size of the aggregation node can be displayed based on the quantity of the second-level nodes included therein. A large quantity of the second-level nodes indicates a greater aggregation node in the view. Therefore, the user can directly learn the quantity of the nodes included in the aggregation node.

In some embodiments, the view 200 includes a plurality of first-level nodes connected to the aggregation node. By way of example, the aggregation node 202 can be connected with a plurality of first-level nodes. For instance, the aggregation node 202 can be connected with a first-level node 204, and other first-level nodes not shown. It would be appreciated that the description about the first-level node is provided only as an example, and the aggregation node can be connected with more or fewer first-level nodes, which is not limited herein.

In block 104, in response to receiving a first interaction operation for the aggregation node, an enlarged aggregation node and the node connected with the enlarged node are simultaneously displayed in the view, where a structural diagram of the plurality of nodes included in the aggregation node is displayed in the enlarged aggregation node.

The structural diagram represents a composition and connections of the plurality of nodes within the aggregation node. The structural diagram illustrates a specific composition of the plurality of second-level nodes included in the aggregation node, enabling the user to directly learn what nodes are included in the aggregation node. For example, in a node-edge graph representing an organizational structure of a company, a certain aggregation node indicates a department, and the structural graph shows respective positions (i.e., a plurality of second-level nodes) in the department. In addition to the nodes, the structural graph displays connections between the nodes, including direct or indirect connections between the nodes, which reflect information on business associations, data flows, logical relationships, or the like, between those nodes.

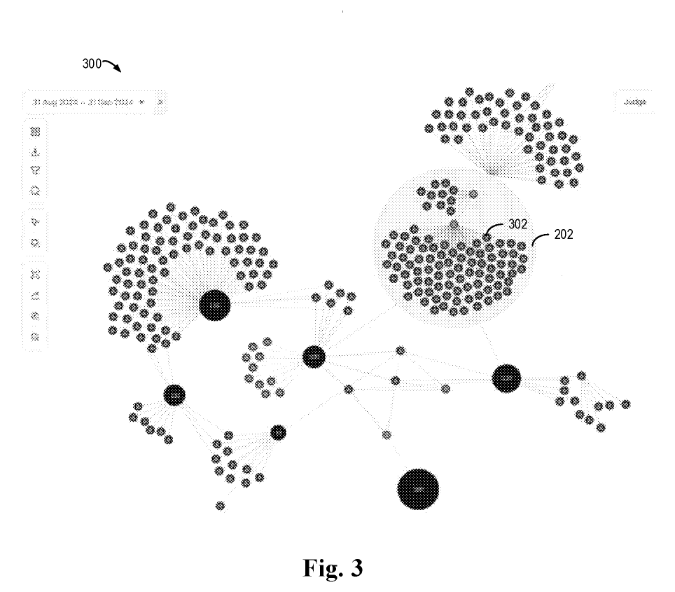

FIG. 3 illustrates a schematic diagram of a view 300, in which an aggregation node is in an expanded state, according to embodiments of the present disclosure. As shown therein, the view 300 displayed on the screen of the device may include an enlarged aggregation node 202, and a structural graph 302 composed of a plurality of nodes included in the enlarged aggregation node 202.

In some embodiments, when an interaction operation (referred to as first interaction operation for ease of explanation and description) for the aggregation node 202 is received, the enlarged aggregation node 202, and nodes connected with the enlarged aggregation node 202 are displayed simultaneously in the view 300. In other words, in response to receiving the first interaction operation, the relationships between the aggregation node 202 and the edges and the nodes connected thereto, as displayed in the view 300, are kept unchanged while only the aggregation node 202 is enlarged. In some embodiments, the first interaction operation may be a click operation. It would be appreciated that the first interaction operation may be other interaction operation, which is not limited herein.

In some embodiments, when the first interaction operation for the aggregation node 202 is received, the structural diagram 302 of the multiple second-level nodes included therein is displayed within the enlarged aggregation node. In some embodiments, when the first interaction operation for the aggregation node 202 is received, the aggregation node 202, a plurality of first-level nodes connected with the aggregation node 202, and edges connecting the aggregation node 202 with the plurality of first-level nodes are highlighted. It would be appreciated that the description about the enlarged aggregation node and the structural graph therein is provided only as an example, i.e., the first interaction operation may be performed on more aggregation nodes included in the view, and the enlarged aggregation node and the structural graph included therein may be displayed, which is not limited herein.

Therefore, second-level nodes included in the aggregation node can be viewed by clicking on an aggregation node, while it is unnecessary to jump to a new page or view to view a structural diagram included in the aggregation node. In this way, the aggregation node and the structural diagram of the second-level nodes can be displayed in the same view, which can reduce the operation steps required to view the structural diagram, and enable the user to directly view the structural diagram of the plurality of nodes included in the aggregation node.

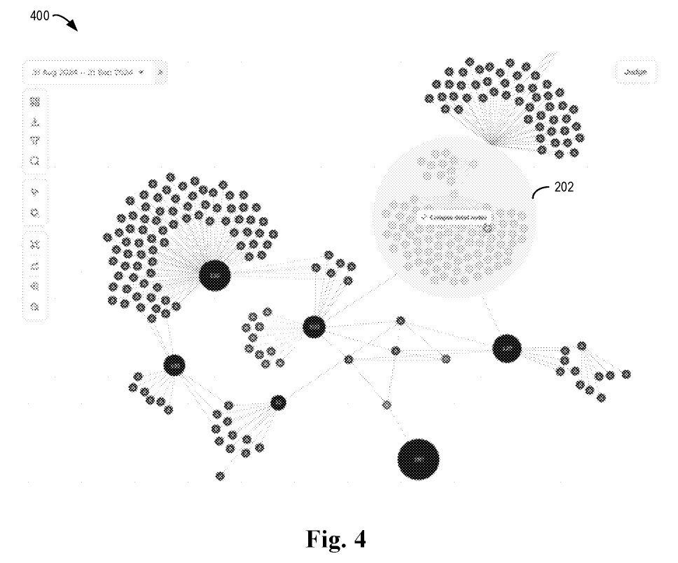

FIG. 4 illustrates a schematic diagram of a view 400, in which an aggregation node is to be collapsed, according to embodiments of the present disclosure. The view 400 includes an enlarged aggregation node 202.

In some embodiments, when an interaction operation for the enlarged aggregation node is received, the enlarged aggregation node is reduced to its original size. Referring to FIG. 4, when an interaction operation (referred to as second interaction operation for ease of explanation and description) for the enlarged aggregation node 202 is received, a gray circular area and a collapse button are displayed within the enlarged aggregation node 202. When an interaction operation (referred to as third interaction operation for ease of explanation and description) for the collapse button, the enlarged aggregation node 202 is reduced to its original size (i.e., the size of the aggregation node 202 in the view 200). In some embodiments, the second interaction operation may be a hover operation, and the third interaction operation may be a click operation. It would be appreciated that the second interaction operation and the third interaction operation may be any appropriate interaction operation, which is not limited herein.

With the method, a structural graph of a plurality of second-level nodes included in the aggregation node can be flexibly expanded or collapsed according to the user needs, such that the user can simultaneously view the structural graph of the second-level nodes included in the aggregation node and the position of the aggregation node containing the second-level nodes in the view, meeting the user’s needs for convenient and quick viewing.

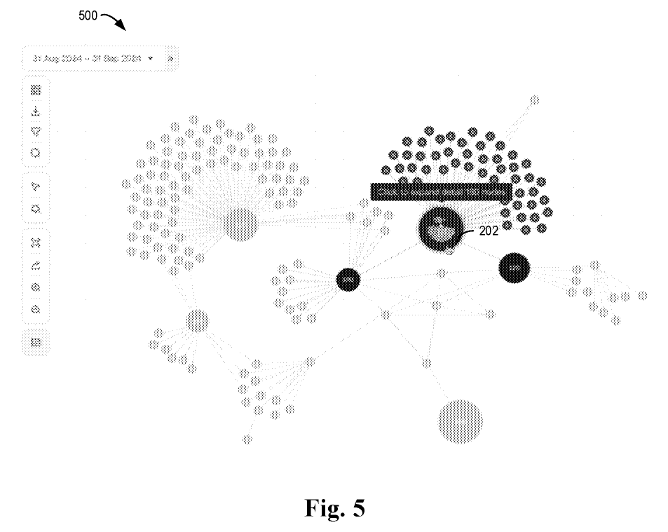

FIG. 5 illustrates a schematic diagram of a view of a thumbnail for displaying an aggregation node according to embodiments of the present disclosure. The view 500 includes an aggregation node 202 with a thumbnail structure.

In some embodiments, in response to receiving a second interaction operation for the aggregation node, a thumbnail of the structural graph is displayed within the aggregation node while the size of the aggregation node is maintained. Referring to FIG. 5, when the second interaction operation for the aggregation node 202 is received, including, but not limited to, a hover operation performed by the user through the mouse, a long press or specific gesture operation performed on the touchscreen, or the like, the thumbnail of the structural graph of the second-level nodes is displayed in a predetermined area within the aggregation node while the original size and the position of the aggregation node 202 are maintained. Wherein, the thumbnail presents the hierarchical relationships and the connection structure of the plurality of nodes included in the aggregation node 202 in a scaled-down form, which can be differentiated using a semi-transparent background or an outline box, and labels or identifiers of key nodes can also be provided selectively in the thumbnail.

In some embodiments, when the second interaction operation for the aggregation node 202 is received, the aggregation node 202 with a thumbnail structure, the first-level nodes connected with the aggregation node 202, and edges connecting the aggregation node 202 with the first-level nodes are highlighted in the view 500. In some embodiments, when the second interaction operation for the aggregation node 202 is received, an operation prompt box can be displayed on the screen of the device, to guide the user to click on the aggregation node 202 to expand the latter.

With the method, a thumbnail of a structural graph of second-level nodes included in the aggregation node can be displayed within the aggregation node, to enable the user to quickly preview the thumbnail corresponding to the aggregation node.

As aforementioned, the node-edge graph is a visual graph for displaying a large amount of data relationships. The node-edge graph can be used to demonstrate associations between nodes, from which the user can analyze specific data semantics. For example, if two nodes are connected by an edge, it is indicated that the data represented by the two nodes are directly associated with each other; if three nodes are connected by two edges, it is indicated that the first node and the third node are indirectly associated. In the actual application scenario, although the structure of the node-edge associations may be complex, they are all directed towards certain data semantics. For example, in a data scenario of top-up, a node represents a user ID or a cellphone device, and if the node-edge graph has a graphical feature that a plurality of nodes representing user IDs converge to a node representing a device, the user can determine that the plurality of user IDs (nodes) collectively make payments (edge) to the device (node), thus forming a pattern of interest. In the prior art, the node-edge graph lacks visual emphasis on the association structure, and the user needs to rely on experience to visually identify the data semantics hidden in nodes and edges, which heavily depends on personal experience, resulting in low identification efficiency and implying a risk of overlooking the node-edge relationship structure with data semantics.

The embodiments of the present disclosure further provide a method for emphasizing a specific node-edge structure based on a node-edge graph. In the node-edge graph, there may be various combinations of nodes and edges, but some information with specific meanings is generally presented in some fixed node-edge structures in the graph, which forms an information pattern that conveys specific semantics. In the legacy design of the node-edge graph, a user needs to identify and determine a specific node-edge structure with the eyes, and rely on the personal experience to filter out information features entailed in the node-edge graph. In order to solve the problem, the embodiments of the present disclosure further provide a method for highlighting those structures for users, without users’ efforts, which can enable the users to directly focus on the special information pattern in the graph, solve the problem of requiring users’ effort in identification in the prior art, and accelerate the speed of the users for interpreting the node-edge graph.

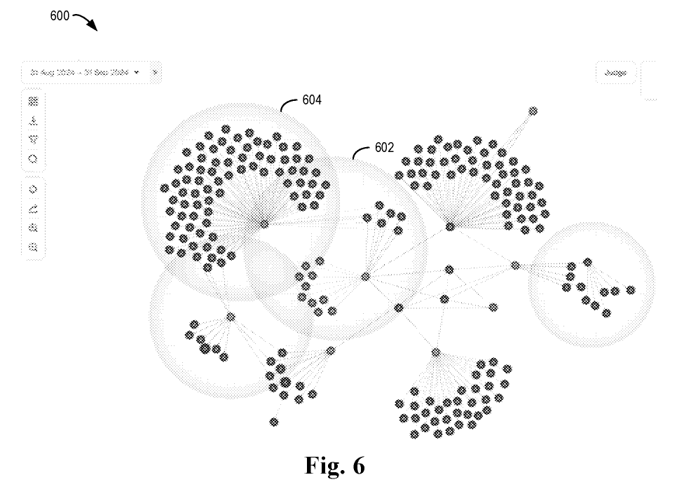

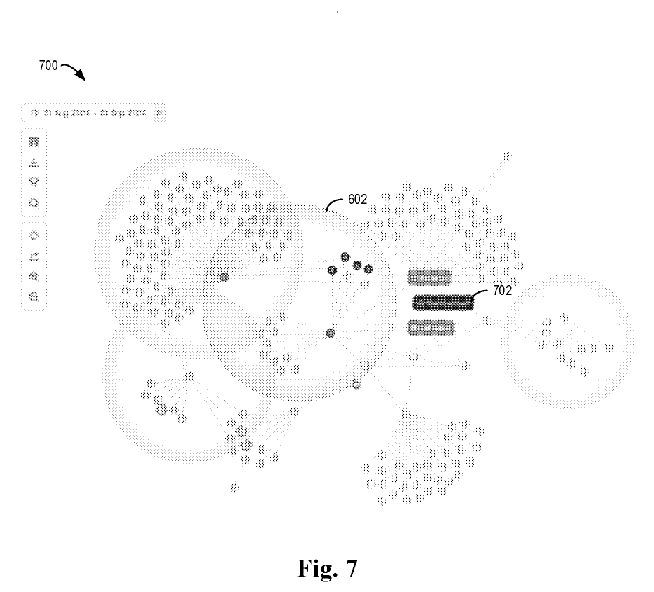

In some embodiments, visual graphical bubbles can be used to highlight specific node-edge structures in an node-edge graph, and nodes and edges involved in those structures. In a colorful node-edge graph, when a user clicks on a bubble, nodes and edges of a certain specific structure (except for the nodes and edges of this structure, other nodes and edges lose their hue and turn gray), and a specific information pattern included in the structure are highlighted in the node-edge graph. For instance, if two sets of nodes are a plurality of nodes that respectively converge to one of them, it is indicated that the two sets of nodes have a jump association through the node. In a real meaningful case, assumed that a node is a person and an edge is a social relationship, the node-edge structure shows that the two groups of people know a middleman, which indicates a possibility that the two social circles overlap each other via the middleman. With such visual means, elements such as color, bubble, and the like, are changed, which can enable the user to directly capture the specific node-edge aggregation links hidden and entailed in the graph, saving the user’s efforts in identification, and can simultaneously help the user quickly determine the specific information semantics conveyed by the node-edge structure, saving the analysis time. For ease of understanding, further description will be made on FIGS. 6 and 7.

FIG. 6 illustrates a schematic diagram of a view 600, in which node-edge structures within bubbles are highlighted, according to embodiments of the present disclosure. The view 600 may include a bubble 602, a bubble 604, and more bubbles not shown.

In some embodiments, the view 600 may have one or more bubbles displayed therein, where each bubble includes nodes and edges that form a pattern of interest. Wherein, the pattern of interest indicates a sub-structure of specific business or technical significance in the node-edge graph.

In some embodiments, when a bubble is selected from one or more bubbles in the view 600, all nodes and edges within the bubble is highlighted in the view 600, to make the node-edge structure within the bubble prominent, while other areas in the view 600 are displayed in grayscale. By way of example, in the view 600, if the bubble 602 is selected, all the nodes and edges within the bubble 602 are highlighted while areas outside the bubble 602 are displayed in grayscale; if the bubble 604 is selected, all the nodes and edges within the bubble 604 are highlighted while areas outside the bubble 604 are displayed in grayscale. With the method, the user can quickly identify and locate nodes and edges within a bubble.

FIG. 7 illustrates a schematic diagram of a view 700, in which a part of node-edge structures within bubbles are highlighted, according to embodiments of the present disclosure.

In some embodiments, a name of at least one pattern of interest associated with a highlighted bubble is displayed. In FIG. 7, when the bubble 602 is selected and highlighted, names of three patterns of interest associated with the bubble 602 are displayed close to the bubble 602. It would be appreciated that the number of names of patterns may be greater or smaller, which is not limited herein.

In some embodiments, in response to the name of the pattern of interest being selected, nodes and edges that form the pattern corresponding to the name are highlighted, and the highlighting is removed from other nodes and edges within a bubble. In FIG. 7, when a pattern of interest 702 is selected, only nodes and edges of a specific pattern corresponding to the name of the pattern of interest 702 are highlighted, rather than all the elements within the bubble, while the highlighting is removed from other nodes and edges within the bubble 602, to ensure that the user focuses on the selected pattern. The method can enable the user to quickly locate a sub-structure in a node-edge graph, thereby improving the interaction efficiency and the data analysis accuracy.

The example embodiments described above with reference to FIGS. 1-7 provide a display method for an aggregation node. As compared with the prior art, the method has the following advantage: a user can view second-level nodes included in the aggregation node by clicking on an aggregation node, while it is unnecessary to jump to a new page or view to view a structural diagram included in the aggregation node. In this way, the aggregation node and the structural diagram of the second-level nodes can be displayed in the same view, which can reduce the operation steps required to view the structural diagram, and enable the user to directly view the structural diagram of the plurality of second-level nodes included in the aggregation node. In addition, there is further provided a method of viewing nodes and edges corresponding to a pattern of interest using a bubble, to enable the user to quickly locate a sub-structure in a node-edge graph, thereby improving the interaction efficiency and the data analysis accuracy.

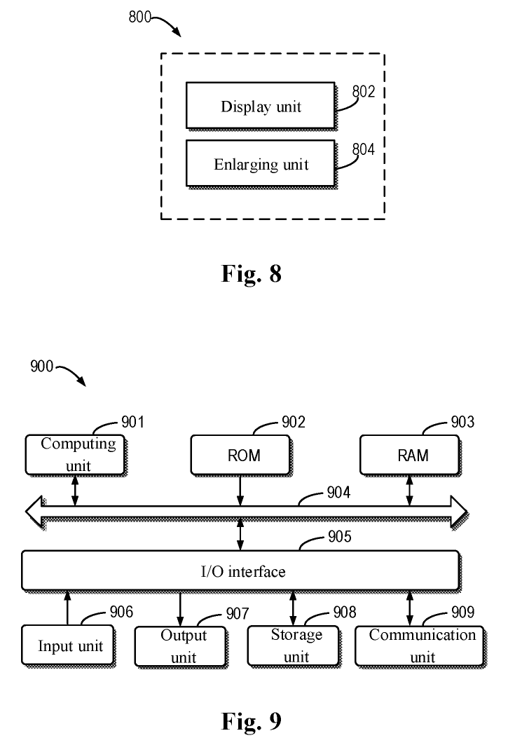

FIG. 8 illustrates a schematic diagram of a display apparatus 800 according to embodiments of the present disclosure. The apparatus 800 can be used to implement the methods or steps described with reference to FIGS. 1-7.

As shown therein, the apparatus 800 includes: a display unit 802 and an enlarging unit 804. The display unit 802 is configured to display a view comprising a node-edge graph, where the node-edge graph includes an aggregation node composed of a plurality of nodes, and a node directly connected to the aggregation node. The enlarging unit 804 is configured to simultaneously display, in response to receiving a first interaction operation for the aggregation node, an enlarged aggregation node and the node connected with the enlarged node in the view, where a structural diagram of the plurality of nodes included in the aggregation node is displayed in the enlarged aggregation node.

In some embodiments, the apparatus 800 can be configured to: in response to receiving a second interaction operation for the aggregation node, display a thumbnail of the structural diagram within the aggregation node while maintaining a size of the aggregation node.

In some embodiments, the first interaction operation is a click operation, and the second interaction operation is a hover operation.

In some embodiments, the apparatus 800 can be configured to: highlight the aggregation node, the node, and an edge connecting the aggregation node and the node.

In some embodiments, the apparatus 800 can be configured to: in response to receiving a third interaction operation for the enlarged aggregation node, reduce the enlarged aggregation node to its original size.

In some embodiments, the apparatus 800 can be configured to: display a number in association with the aggregation node in the node-edge graph, where the number represents the quantity of the plurality of nodes included in the aggregation node.

In some embodiments, a size of the aggregation node is determined based on the quantity of the plurality of nodes included in the aggregation node.

In some embodiments, the apparatus 800 can be configured to: display one or more bubbles in the view, each bubble contains nodes and edges that form at least one pattern of interest; and in response to that a bubble among the one or more bubbles is selected, highlight nodes and edges within the bubble.

In some embodiments, the apparatus 800 can be configured to: display a name of at least one pattern of interest associated with the bubble; and in response to the name being selected, highlight nodes and edges that form a pattern of interest corresponding to the name, and remove the highlighting from other nodes and edges within the bubble.

It is worth noting that more actions or steps as shown in FIGS. 1-7 can be implemented by the apparatus 800 as shown in FIG. 8. For example, the apparatus 800 may include more modules or units to implement the actions or steps described above, or some units or modules shown in FIG. 8 can be further configured to implement the actions or steps described above. Details are omitted here for brevity.

FIG. 9 illustrates an example block diagram of an example device 900 that can implement embodiments of the present disclosure. As shown therein, the device 900 may include a computing unit 901 which can execute various actions and processing based on programs stored in a Read Only Memory (ROM) 902 or a program loaded from a storage unit 906 to a Random Access Memory (RAM) 903. RAM 903 stores therein various programs and data required for operations of the device 900. The computing unit 901, the ROM 902, and the RAM 903 are connected to one another via a bus 904. An input/output (I/O) interface 905 is also connected to the bus 904.

A plurality of components in the device 900 may be connected to the I/O interface 905, including: an input unit 906 including, for example, a keyboard, a mouse, and the like; an output unit 907 including various types of displays, loudspeakers, and the like; a storage unit 908 including, for example, a magnetic disk, a compact disc, or the like; and a communication unit 909, for example, a network card, a modem, a wireless communication transceiver, or the like. The communication unit 909 can allow the device 900 to exchange information/data with other devices through a computer network such as Internet, and/or various kinds of telecommunication networks.

The computing unit 901 may be various types of general purpose and/or specific purpose processing components having a processing and computing capability. Some examples of the computing unit 901 include, but are not limited to, a Central Processing Unit (CPU), a Graphics Processing Unit (GPU), various types of specific-purpose Artificial Intelligence (AI) computing chips, various types of computing units having machine learning model algorithms run thereon, a Digital Signal Processor (DSP), any appropriate processor, controller, microcontroller, or the like. The computing unit 901 can execute various methods and processing described above, for example, the method 100. For example, the method 100 may be implemented as computer software programs that are tangibly included in a machine readable medium, e.g., the storage unit 908. In some embodiments, part or all of the computer programs may be loaded and/or mounted onto the device 900 via ROM 902 and/or communication unit 909. When the computer program is loaded to the RAM 903 and executed by the computing unit 901, one or more steps of the method 100 as described above can be executed. Alternatively, in other embodiments, the computing unit 901 may be configured in any other appropriate manners (for example, by means of firmware) to perform the method 100.

In some embodiments, the method and process described above may be implemented as a computer program product. The computer program product may include a computer readable storage medium having stored thereon computer readable program instructions for performing various aspects of the present disclosure.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals sent through a wire.

Computer readable program instructions described herein can be downloaded to corresponding computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the corresponding computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGAs), or Programmable Logic Arrays (PLAs) may execute the computer readable program instructions by utilizing state information of the computer readable program instructions to personalize the electronic circuitry, in order to perform aspects of the present disclosure.

These computer readable program instructions may be provided to a processing unit of a general purpose computer, special purpose computer, or other programmable data processing device to produce a machine, such that the instructions, when executed via the processing unit of the computer or other programmable data processing device, create apparatuses for implementing the functions/actions specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored thereon includes an article of manufacture including instructions which implement aspects of the functions/actions specified in the flowchart and/or block diagram block or blocks.

The computer readable program instructions may also be loaded onto a computer, other programmable data processing devices, or other devices to cause a series of operational steps to be performed on the computer, other programmable devices or other devices to produce a computer implemented process, such that the instructions which are executed on the computer, other programmable devices, or other devices implement the functions/actions specified in the flowchart and/or block diagram block or blocks.

The flowchart and block diagrams illustrate the architecture, functionality, and operation of possible implementations of systems, methods and computer program products according to various embodiments of the present disclosure. In this regard, each block in the flowchart or block diagrams may represent a module, snippet, or portion of code, which includes one or more executable instructions for implementing the specified logical function(s). In some alternative implementations, the functions noted in the block may occur out of the order noted in the images. For example, two blocks in succession may, in fact, be executed substantially concurrently, or the blocks may sometimes be executed in the reversed order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A display method, comprising:
displaying a view comprising a node-edge graph, the node-edge graph comprising an aggregation node composed of a plurality of nodes, and a first node directly connected to the aggregation node; and
in response to receiving a first interaction operation for the aggregation node, simultaneously displaying an enlarged aggregation node and the first node connected with the enlarged aggregation node in the view, wherein a structural diagram of the plurality of nodes included in the aggregation node is displayed in the enlarged aggregation node.

2. The method of claim 1, further comprising:
in response to receiving a second interaction operation for the aggregation node, displaying a thumbnail of the structural diagram within the aggregation node while maintaining a size of the aggregation node.

3. The method of claim 2, wherein the first interaction operation is a click operation, and the second interaction operation is a hover operation.

4. The method of claim 2, further comprising:
highlighting the aggregation node, the first node, and an edge connecting the aggregation node and the first node.

5. The method of claim 1, further comprising:
in response to receiving a third interaction operation for the enlarged aggregation node, reducing the enlarged aggregation node to its original size.

6. The method of claim 1, further comprising:
displaying a number in association with the aggregation node in the node-edge graph, wherein the number represents a quantity of the plurality of nodes included in the aggregation node.

7. The method of claim 1, wherein a size of the aggregation node is determined based on a quantity of the plurality of nodes included in the aggregation node.

8. The method of claim 1, further comprising:
displaying one or more bubbles in the view, each bubble contains nodes and edges that form at least one pattern of interest; and
in response to that a first bubble among the one or more bubbles is selected, highlighting nodes and edges within the first bubble.

9. The method of claim 8, further comprising:
displaying a name of at least one pattern of interest associated with the first bubble; and
in response to the name being selected, highlighting nodes and edges that form a pattern of interest corresponding to the name, and removing the highlighting from other nodes and edges within the first bubble.

10. A device, comprising:
at least one processing unit; and
at least one memory coupled to the at least one processing unit and storing instructions executable by the at least one processing unit, wherein the instructions, when executed by the at least one processing unit, cause the device to perform a method comprising:
displaying a view comprising a node-edge graph, the node-edge graph comprising an aggregation node composed of a plurality of nodes, and a first node directly connected to the aggregation node; and
in response to receiving a first interaction operation for the aggregation node, simultaneously displaying an enlarged aggregation node and the first node connected with the enlarged aggregation node in the view, wherein a structural diagram of the plurality of nodes included in the aggregation node is displayed in the enlarged aggregation node.

11. The device of claim 10, the method further comprising:
in response to receiving a second interaction operation for the aggregation node, displaying a thumbnail of the structural diagram within the aggregation node while maintaining a size of the aggregation node.

12. The device of claim 11, wherein the first interaction operation is a click operation, and the second interaction operation is a hover operation.

13. The device of claim 11, the method further comprising:
highlighting the aggregation node, the first node, and an edge connecting the aggregation node and the first node.

14. The device of claim 10, the method further comprising:
in response to receiving a third interaction operation for the enlarged aggregation node, reducing the enlarged aggregation node to its original size.

15. The device of claim 10, the method further comprising:
displaying a number in association with the aggregation node in the node-edge graph, wherein the number represents a quantity of the plurality of nodes included in the aggregation node.

16. The device of claim 10, wherein a size of the aggregation node is determined based on a quantity of the plurality of nodes included in the aggregation node.

17. The device of claim 10, the method further comprising:
displaying one or more bubbles in the view, each bubble contains nodes and edges that form at least one pattern of interest; and
in response to that a first bubble among the one or more bubbles is selected, highlighting nodes and edges within the first bubble.

18. The method of claim 17, further comprising:
displaying a name of at least one pattern of interest associated with the first bubble; and
in response to the name being selected, highlighting nodes and edges that form a pattern of interest corresponding to the name, and removing the highlighting from other nodes and edges within the first bubble.

19. A non-transitory computer storage medium comprising machine-executable instructions that, when executed by a device, cause the device to perform a method comprising:
displaying a view comprising a node-edge graph, the node-edge graph comprising an aggregation node composed of a plurality of nodes, and a first node directly connected to the aggregation node; and
in response to receiving a first interaction operation for the aggregation node, simultaneously displaying an enlarged aggregation node and the first node connected with the enlarged aggregation node in the view, wherein a structural diagram of the plurality of nodes included in the aggregation node is displayed in the enlarged aggregation node.

20. The non-transitory computer storage medium of claim 19, the method further comprising:
in response to receiving a second interaction operation for the aggregation node, displaying a thumbnail of the structural diagram within the aggregation node while maintaining a size of the aggregation node.
